(19) United States
(12) Patent Application Publication
(10) Pub. No.: US 2011/0303511 A1
(43) Pub. Date: Dec. 15, 2011

(54) SMOKELESS TOBACCO PRODUCTS AND PROCESSES

(75) Inventors: Paul Andrew Brinkley, Winston-Salem, NC (US); David Charles Bovender, Kernersville, NC (US)

(73) Assignee: R.J. Reynolds Tobacco Company

(21) Appl. No.: 13/185,269

(22) Filed: Jul. 18, 2011

Related U.S. Application Data
(62) Division of application No. 12/181,051, filed on Jul. 28, 2008, now abandoned.

(51) Int. Cl. B65G 33/08

(52) U.S. Cl. 198/617

(57) ABSTRACT

A method for preventing packing of tobacco in a tobacco hopper is provided. The method comprises the steps of providing a feed screw with a plurality of pins extending from an outer diameter of the feed screw and providing an agitator with a plurality of pins extending from an outer diameter of said outer diameter. The feed screw and said agitator screws are rotated in opposite directions to move tobacco through the hopper.

### CROSS REFERENCE TO RELATED APPLICATION

This is a divisional of U.S. patent application Ser. No. 12/181,051, filed Jul. 28, 2008, which incorporated by reference herein.

### FIELD OF THE INVENTION

The present invention relates to tobacco products and packaging for tobacco products in smokeless form, including those smokeless tobacco products characterized as “snus.”

### BACKGROUND OF THE INVENTION

Tobacco may be enjoyed in a so-called “smokeless” form. Particularly popular smokeless tobacco products are employed by inserting some form of processed tobacco or tobacco-containing formulation into the mouth of the user.

Various types of smokeless tobacco products are set forth in U.S. Pat. Nos. 1,376,586 to Schwartz; 4,513,756 to Pittman et al.; 4,528,993 to Sensabaugh, Jr. et al.; 4,624,269 to Story et al.; 4,987,907 to Townsend; 5,092,352 to Sprinkle, III et al.; 5,387,416 to White et al.; and Des. 335,934 to Howard; U.S. Pat. Pub. No. 2005/0244521 to Strickland et al. and 2006/0162732 to Winn et al.; U.S. Pat. Pub. Nos. 2006/0191548 to Strickland et al., 2007/0261707 to Winterson et al., 2007/0062549 to Holton, Jr. et al.; 2007/0186941 to Holton, Jr. et al.; 2008/0166395 to Roush; and PCT Pub. Nos. WO 04/095959 to Arnarp et al.; WO 05/063060 to Atchley et al.; WO 06/004480 to Engstrom; WO 05/041699 to Quinter et al.; and WO 07/138,484 to Wrenn et al.; each of which is incorporated herein by reference. One type of smokeless tobacco product is referred to as “snuff.” Snuff typically is formulated in “moist” or “dry” forms.

Representative smokeless tobacco products have been marketed under the trade names Oliver Twist by House of Oliver Twist A/S; Copenhagen, Skoal, SkoalDry, Rooster, Red Seal, Husky, and Revel by U.S. Smokeless Tobacco Co.; “taboka” by Philip Morris USA; and Levi Garrett, Peachy, Taylor's Pride, Kodiak, Hawken Wintergreen, Grizzly, Dental, Kentucky King, Mammoth Cave by Conwood Sales Co., L.P., Interval by Brown & Williamson Tobacco Corp., and Ariva and Stonewall by Star Scientific, Inc.

Representative types of snuff products, commonly referred to as “snus,” are manufactured in Europe, particularly in Sweden, by or through companies such as Swedish Match AB, Fiedler & Lundgren AB, Gustavus AB, Skandinavisk Tobakskompagni A/S and Rocker Production AB. Snus products available in the U.S.A. are marketed under the trade names Camel Snus Frost, Camel Snus Original and Camel Snus Spice by R. J. Reynolds Tobacco Company.

Snus products, such as Camel Snus Original, are commonly supplied in small teabag-like pouches. The pouches are typically a nonwoven fleece material, and contain about 0.4 to 1.5 grams of pasteurized tobacco. These products typically remain in a user's mouth for about 10-30 minutes. Unlike certain other smokeless tobacco products, snus do not require expectoration by the user.

Consumers who formerly used smoking products and switch over to snus or other pouched tobacco products may find that the initial feeling in the mouth along the cheek or gum is uncomfortable. Therefore, there exists a need to improve the initial mouth feel of the snus pouch.

The fleece used for snus also may exhibit discoloration after being stored over time. This discoloration typically displays as a yellowing of the fleece material. This discoloration can make the snus pouches unappealing to the consumer. Furthermore, the consumer may assume that the snus pouch has degraded in some fashion because of the discoloration, and dispose of the pouch without using it. There exists a need to reduce this type of discoloration. Furthermore, snus pouches are typically a whitish color, and different flavors of snus are not easily distinguished. There exists a need to have a way to easily identify different snus flavors from sight alone.

Problems exist in the art with respect to efficiently feeding tobacco into pouches. The problems lie in the material flow through the hopper of the high-speed pouching equipment. The feed hoppers are subject to dead zones and rat holes due to the dimensions of the hopper and the properties of the tobacco that is supplied to the hopper. This causes loss of product flow in the hopper. Dead zones occur in the lower area of the hopper, where the slope of the hopper tends to pack the tobacco material against the bottom wall. Rat holes can occur in multiple areas of the middle section of the hopper, and like dead zones, they choke off the flow of tobacco to the feed screw. This requires the operator to regularly clean this area and push the tobacco back into the feed screw. This increases production time and lowers production efficiency. There is a need for improvements to these pouching machines to improve manufacturing speed and efficiency.

Snus are also commonly supplied in various flavors such as Camel Snus Frost and Camel Snus Spice. The snus may be flavored by mixing flavor into the tobacco, adding microcapsules or the like to the tobacco, or adding flavor strips to the tobacco. U.S. patent application Ser. No. 11/781,604 to Dube et al. describes numerous methods of accomplishing this, and is herein incorporated by reference in its entirety. Typically, one flavor is supplied in one package because otherwise, the flavors can leech into each other, which can adversely affect the taste of all of the flavors.

However, while a consumer can use a snus pouch almost anywhere, it is necessary to dispose of the pouch in a convenient fashion once the consumer is through with it. It would be desirable to have a method of disposing of a used snus pouch without necessarily having to conveniently find a suitable disposal container in a timely manner (e.g. a garbage can . . . etc.). For example, after a user has finished a snus pouch or other smokeless tobacco pouch, there is a need to dispose of the pouch. A user must either find a waste disposal container or simply hold on to the used pouch if they do not want to litter. A used snus or other smokeless tobacco pouch is typically damp and unpleasant to keep in a user's pocket. A user could wrap the pouch in paper or tissue of some kind, assuming it is handy. Another alternative would be to put the pouch back in the container, but the used and damp pouch could negatively affect the unused pouches. Furthermore, with the onset of more restrictions on smoking, public areas have a reduced number of ashtrays available for disposal of cigarette butts and other smoked articles. There is also a need for a simple and convenient disposal means for such materials that can be carried by a user. In the case of snuff tins, one method to store used snuff is to provide a rotatable dividing wall to create a separate chamber for storing used snuff, as disclosed in PCT Pub. Nos. WO 08/066,450 and WO 08/066,451, both to Sjoberg et al. Other snus tins containing separate compartments have been disclosed in U.S. Pat. App. No. 29/297,520 to Patel et al. and U.S. Pat. App. No. 29/297,517 to Patel et al. Methods of attaching holding devices for lighters or advertisements on cigarette boxes are disclosed in U.S. Pat. Pub. No. 2008/0128300 to Bahar et al. A cigarette box that can convert into an ashtray for disposal of used cigarette butts is disclosed in U.S. Pat. Pub. No. 2008/0121243 to Galoyan.

Snus products have been packaged in tins, “pucks” or “pots” that are manufactured from metal or plastic such as those disclosed in PCT Pub. Nos. WO 08/066,450 and WO 08/066,451 to Sjoberg et al. In certain circumstances, smokeless tobacco products such as snus are refrigerated prior to sale, typically for the purpose of prolonging the freshness and moisture content thereof. For example, smokeless tobacco products, particularly moist tobacco products, can be refrigerated in order to avoid or retard absorption of contaminants that provide an undesirable flavor or odor to the product, avoid or retard the development discoloration or staining of the product, and to avoid or retard the activity of biologically active microorganisms. For example, smokeless tobacco products, and typically moist snuff types of products, can be refrigerated to retard the effects of enzymatic and other biological activities, pH changes, oxidation, and other effects that have a tendency to shorten product shelf-life or stability. Snus formulations are typically refrigerated at 38°-40° F. during storage and shipping. The need to keep such formulations refrigerated increases the cost of shipping and storing snus. Another method of keeping moist smokeless tobacco products fresh by thermally treating the smokeless tobacco products is disclosed in U.S. Pat. Pub. No. 2008/0156338 to Winterson et al.

It would be desirable to provide efficient and improved snus or other smokeless formulations with improved components, improved methods of manufacturing, and improved packaging, all associated with efficient production of products that provide enjoyment and satisfaction when employed by a user of that smokeless tobacco product.

### SUMMARY OF THE INVENTION

The present invention relates to packaging for tobacco products in smokeless form, including those smokeless tobacco products characterized as “snus.” The products include a smokeless tobacco composition or formulation. For example, the smokeless tobacco formulation includes particles or pieces of tobacco, and may include other ingredients, such as salts, sweeteners, binders, colorants, pH adjusters, fillers, flavoring agents, disintegration aids, antioxidants, humectants, and preservatives. The moisture content of the particles of the tobacco may vary.

The tobacco formulation can be contained within a container, such as a pouch or bag, such as is the type commonly used for the manufacture of snus types of products (e.g., a sealed, moisture permeable pouch that is sometimes referred to as a “portion”). A representative moisture permeable pouch can be composed of a “fleece” type of material. The tobacco formulation is in turn contained within a package. The package is sealed tightly, and is composed of a suitable material, such that the atmospheric conditions within that sealed package are modified and/or controlled; that is, the sealed package can provide a good barrier that inhibits the passage of compositions such as moisture and oxygen therethrough; in addition, the atmosphere within the sealed package can be further modified by introducing a selected gaseous species (e.g., nitrogen, argon, or a mixture thereof) into the package prior to sealing or by drawing a vacuum therein (vacuum sealing). As such, the atmospheric conditions to which the tobacco composition is exposed are controlled during conditions of preparation, packing, storage and handling.

In one aspect, a method for preventing packing of tobacco in a tobacco hopper, comprises the steps of providing a feed screw with a plurality of pins extending from an outer diameter of the feed screw and providing an agitator with a plurality of pins extending from an outer diameter of said outer diameter. The feed screw and said agitator screws are rotated in opposite directions to move tobacco through the hopper.

### BRIEF DESCRIPTION OF THE DRAWINGS

In order to provide an understanding of embodiments of the invention, reference is made to the appended drawings, in which reference numerals refer to components of described exemplary embodiments of the invention. The drawings are exemplary only, and should not be construed as limiting the invention.

FIG. 1. is a perspective view of an open container for smokeless tobacco with part of a removable seal cut away.

FIG. 2 is a perspective view of an open container for smokeless tobacco with the top shown in phantom and a removable seal in place.

FIG. 3 is a perspective view of an open container for smokeless tobacco with a removable seal partly removed.

FIG. 4 is a perspective view of a closed container for smokeless tobacco.

FIG. 5 is an enlarged cross-sectional view of a tobacco product in the form of a snus type of product individually wrapped in an outer package.

FIG. 6 is a cross-sectional view of a tobacco product in the form of a snus type of product, wherein several snus-type products are wrapped in an outer package and that outer package is contained within a generally cylindrical plastic or metal tin.

FIG. 7 is a perspective view of a closed container for smokeless tobacco having a closed onsert attached thereon.

FIG. 8 is a side plan view of the closed container for smokeless tobacco of FIG. 7.

FIG. 9 is a perspective view of the closed container for smokeless tobacco of FIG. 7 with the onsert in an open position.

FIG. 10 is a side plan view of the closed container for smokeless tobacco of FIG. 9.

FIG. 11 is a perspective view of a closed container for smokeless tobacco having a closed onsert attached thereon with a seal in place over the onsert.

FIG. 12 is a side plan view of the closed container for smokeless tobacco of FIG. 11.

FIG. 13 is a perspective view of the closed container for smokeless tobacco of FIG. 11 with the seal partially removed.

FIG. 14 is a side plan view of the closed container for smokeless tobacco of FIG. 11 with the seal partially removed.

FIG. 15 is a perspective view of a container for smokeless tobacco with the top removed and an onsert attached to the interior of the top.

FIG. 16 is a perspective view of a closed container for smokeless tobacco with an onsert attached thereon.

FIG. 17 is a side perspective view of an infeed and metering system for a tobacco pouching machine.

FIG. 18 is a rear perspective view of an infeed and metering system for a tobacco pouching machine.

FIG. 19 is a perspective view of a hopper for the infeed and metering system of a tobacco pouching machine.

FIG. 20 is a perspective view of the infeed and metering system of FIG. 17 showing the formation of a dead zone in the tobacco.

FIG. 21 is a perspective view of a hopper for the infeed and metering system of FIG. 19 showing the formation of a rat hole in the tobacco.

### DETAILED DESCRIPTION OF THE PREFERRED EMBODIMENTS

The present inventions now will be described more fully hereinafter with reference to the accompanying drawings. The inventions may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural referents unless the context clearly dictates otherwise.

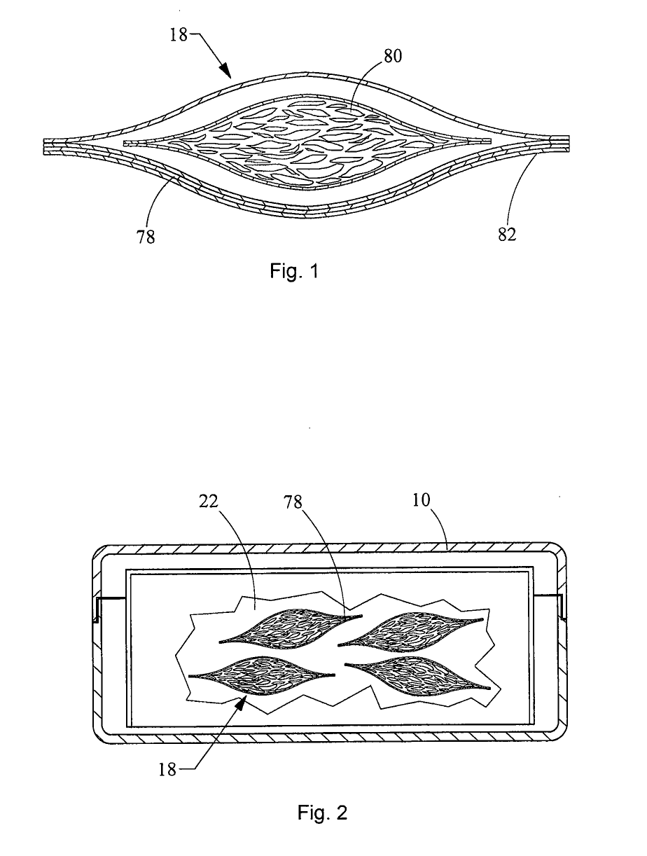

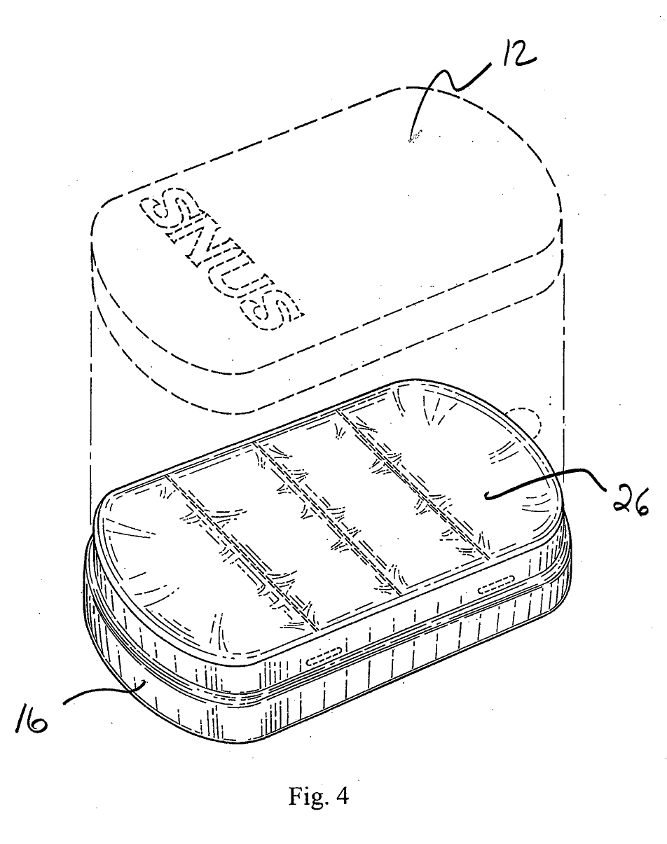

Referring to FIGS. 1-4, a first embodiment of a snus tin 10 is shown such as that disclosed in related U.S. App. Nos. 29/297,520 and 29/297,517 to Patel et al. A typical tin 10 is comprised of plastic or metal top 12 and bottom 16 pieces. FIGS. 1-3 show the tin 10 with the top 12 already removed and FIG. 4 shows the closed tin 10.

A tin 10 is the short, rounded edge, generally cylindrical container used for the marketing of snus products. See, for example, the types of representative snuff-box types of designs set forth in PCT Pub. No. WO 05/016036 to Bjorkholm. Other types of containers that can be suitably modified are plastic or metal type containers set forth in U.S. Pat. No. 7,014,039 to Henson et al. See, also, the types of hard containers used for the commercial distribution of Camel Snus by R. J. Reynolds Tobacco Company; Revel Mint Tobacco Packs type of smokeless tobacco product by U.S. Smokeless Tobacco Corporation; SkoalDry by U.S. Smokeless Tobacco Co. and “taboka” by Philip Morris USA. If desired, the type of container used for the “taboka” product can be adapted to possess a slidable lid (e.g., one that slides generally parallel to the longitudinal axis of the container) so that the container can be opened and closed. If desired, the container can have an accordion or bellows type of design, such that the container can be extended open for filling with smokeless tobacco product during production, and then contracted after filling of the container is complete. If desired, containers can be equipped with suitable seals or grommets, so that when an opened container is re-shut, a good seal is provided.

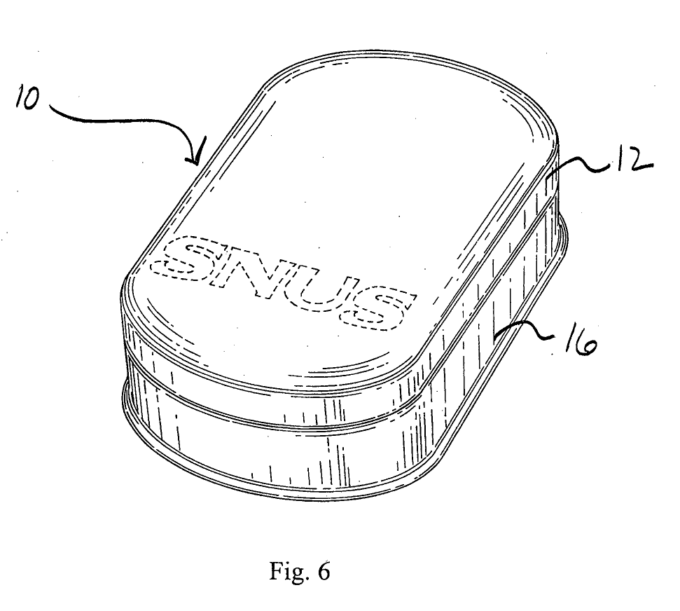

Referring to FIGS. 5 and 6, individual pouch sealed tobacco portions 18 are contained within the tin 10. The number of tobacco portions 18 within the tin 10 can vary, and can be a number such as 10, 12, 15, 20, 25 or 30. The tin 10 is in turn packaged within a sealed outer package which is tightly sealed at each end and is constructed from an appropriate material, such that the atmosphere 22 within that outer package, and within the tin 10, is controlled. For example, the atmosphere within the package can be controlled such that the atmosphere is composed of high purity nitrogen gas, or other suitable gaseous species such as carbon dioxide. Such a method is disclosed in U.S. patent application Ser. No. 12/014,525 to Robinson et al., and is herein incorporated by reference in its entirety. In use, the outer package is opened, the tin 10 is opened, and individual tobacco portions 18 are removed as desired from the tin 10.

Referring to FIGS. 1-3, one embodiment has four separate compartments 24 are provided. Each compartment 24 may contain a different flavor of snuff or snus pouches. Alternatively, all the compartments 24 could contain the same type of smokeless tobacco, and the provision of the separate compartments allows a user to open one compartment 24 at a time. The other compartments 24 remain airtight and the freshness of the smokeless tobacco in the sealed compartments 24 is not compromised.

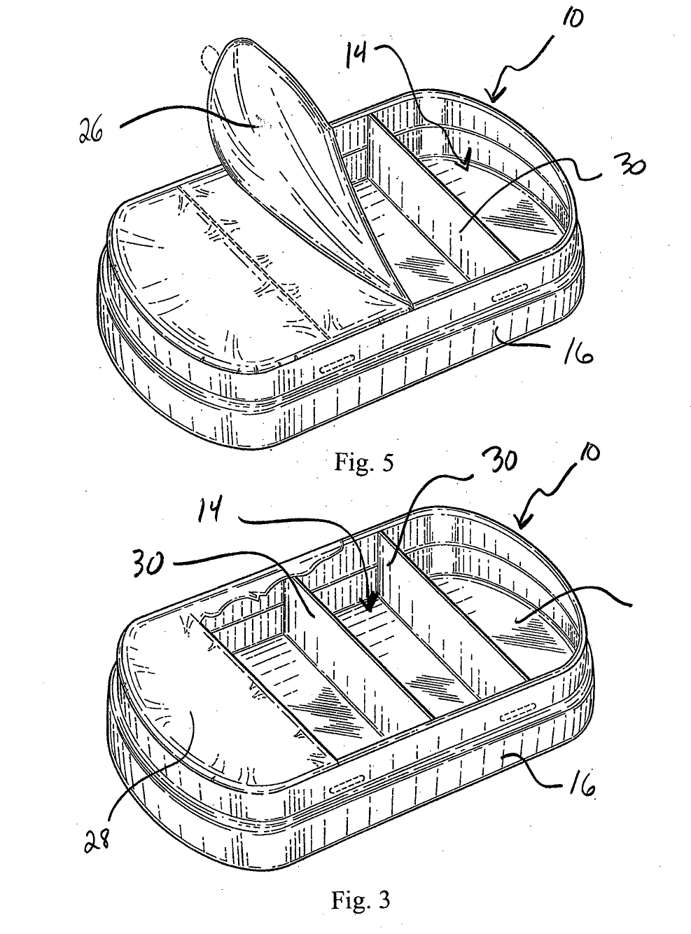

In the embodiment shown in FIG. 3, a single removable flap 26 covers all four compartments 24 and a user peels back the flap 26 to open one or more compartments 24. Alternatively, each compartment 24 could have an individual flap 28, as shown in FIG. 1, allowing a user to remove one or more flaps to open one or more compartment 24. The flaps 26, 28 could also be resealable. The compartments 24 could take any number of shapes. Some could be larger than others, and contain different amounts or flavors of smokeless tobacco.

The flaps 26, 28 can be constructed from various materials known in the art capable of maintaining an air and moisture tight seal. For example, metal foil/paper laminates, metalized paper, plastic wrappers, metalized polymeric film or low permeability transparent polymeric sheets are effective. Exemplary materials are disclosed in U.S. Pat. Pub. No. 2004/0217023 to Fagg et al. and U.S. Pat. No. 7,124,883 to Thomas et al., both of which are herein incorporated in their entirety. It is preferred to utilize a low-permeability material for the construction of the tin 10 and the internal compartment dividers 30 to further reduce flavors or aromas leeching between the compartments 24. Such a material could be an injection-moldable polymeric material, typically a thermoplastic or thermosetting polymer such as polypropylene, polyethylene terephthalate (“PET”) or polyethylene vinyl alcohol. Other exemplary injection-moldable materials that can be utilized for the tin 10 and/or the compartment dividers 30 are acrylonitrile butadiene styrene (“ABS”), polyethylene, polyvinyl chloride (“PVC”) and polystyrene. In order to further reduce the leeching of flavors into the tin 10 materials and vice versa, the mold can be lined with aluminum foil such that there is an aluminum layer on the inside surface 32 of the tin 10.

The low-permeability material could also be metallic, and the material used for the lids 12 and body 16 could differ from the material used for the internal dividers 30. Furthermore, the lid 12, body 16, and internal dividers 30 could all be comprised of different materials.

The flaps 26, 28 could also incorporate other features. Words, colors or pictures could be stamped or printed on the flaps 26, 28 to designate the type of tobacco in each compartment 24. The material itself could be colored, rather than having color stamped on it. Adhesives known in the art can be used to seal the flaps 26, 28 in place and to reseal them in place once they have been opened. Exemplary materials that can be utilized to seal the flaps 26, 28 closed may be low, moderate and high tack reclosable adhesives. These adhesives can be based on natural rubber, hot melt rubber (synthetic), acrylic or silicone.

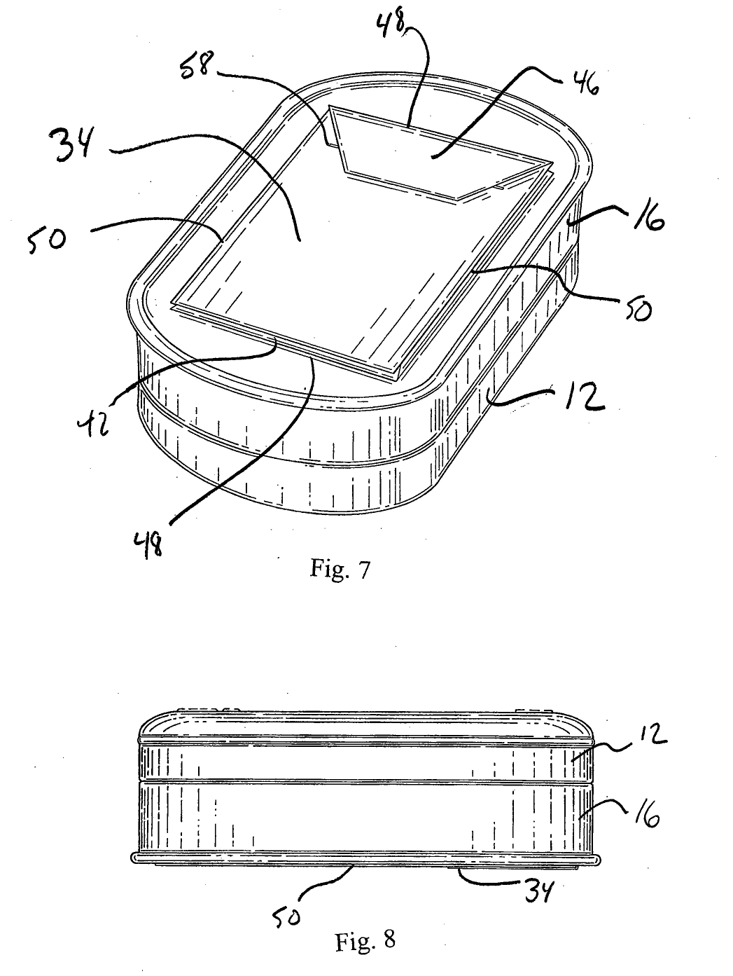

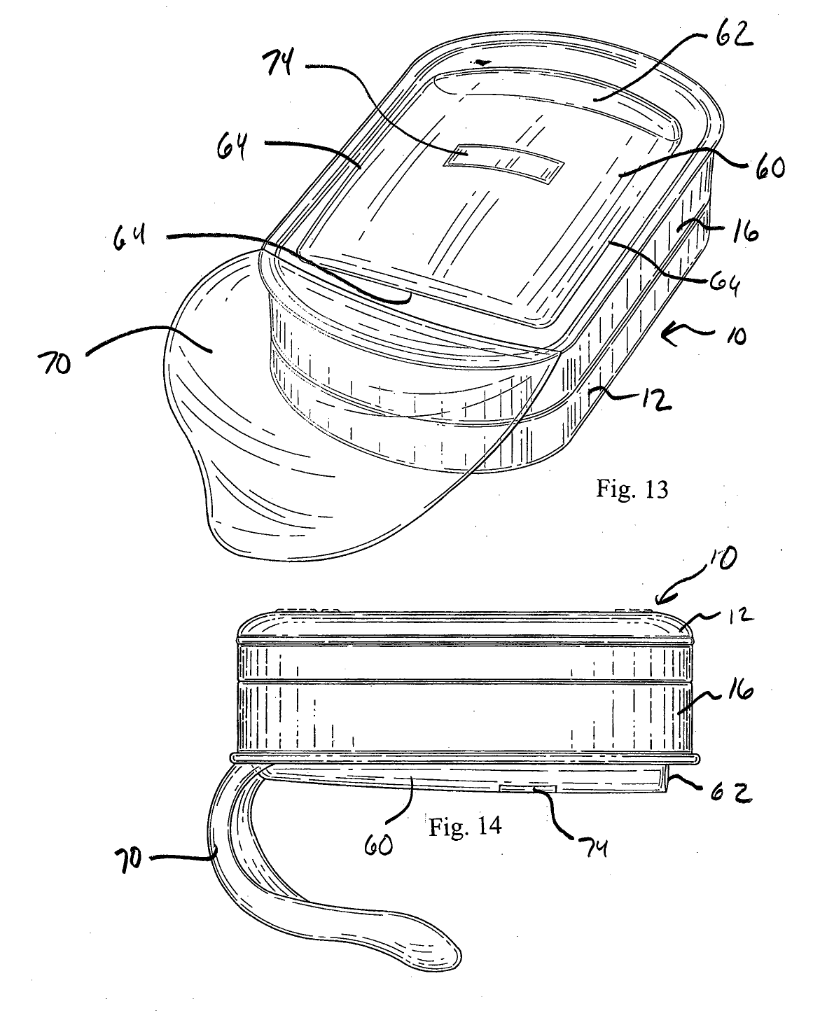

Referring to FIGS. 7-16, another embodiment of a container 10 for a smokeless tobacco product is shown. In a first embodiment, the container 10 shown in FIGS. 7-10 includes a package onsert 34 that is capable of holding one or more used smokeless tobacco pouches 18. With respect to the embodiment above, as previously stated, the used pouches 18 could be stored in one of the separate compartments 24 that has already been emptied of pouches 18.

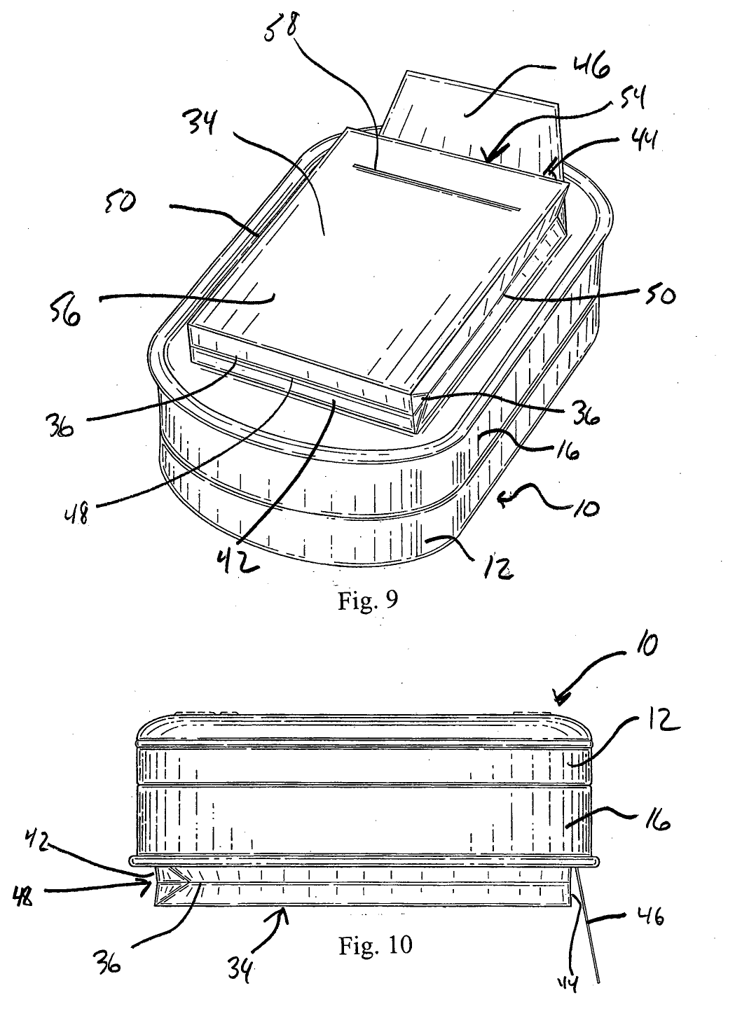

In this embodiment, the onsert 34 is positioned on the outside of the smokeless tobacco container 10 as shown in FIGS. 7-10. The onsert 34 is provided in a substantially flat initial form so that it does not significantly increase the size of the smokeless tobacco container 10. The onsert 34 is designed to expand as it is filled. In a first embodiment of such an onsert 34, shown in FIGS. 7-10, the onsert 34 is an “accordion-type” onsert 34 with at least one accordion pleat 36 on three sides. The onsert 34 also has a closed end 42 and an open end 44. The open end 44 is preferably supplied with a flap 46 that can be folded over the open end 44. The open end 44 can be on the narrow side 48, as shown in FIG. 9, or on the wide side 50.

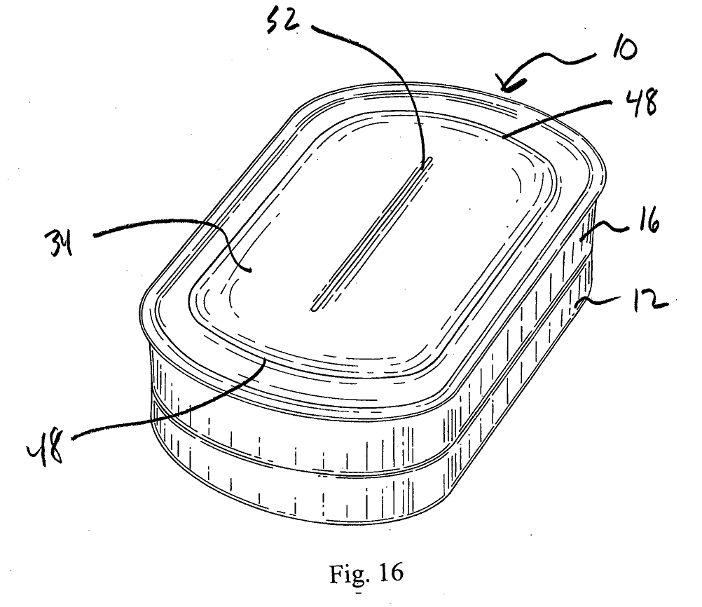

The flap 46 can be bifold or multifold, and can include temporary or permanent adhesive to seal the onsert 34 closed. Exemplary materials that can be utilized to seal the flap 46 closed may be low, moderate and high tack reclosable adhesives. These adhesives can be based on natural rubber, hot melt rubber (synthetic), acrylic or silicone. A further alternative embodiment of the onsert 34, shown in FIG. 16, includes a slit 52 in the outer surface 56, with the narrow 48 and wide 50 side surfaces closed. In use, the sides 48 of the onsert 34 are squeezed together to open the slit 52 in the outer surface 56. The used pouch 18 is then placed in the onsert 34.

The onsert 34 can be made from waterproof or water impermeable materials such as paper, plastic, foil, waxed paper, or other commonly used materials. Furthermore, the onsert 34 can be multi-ply, with one ply being waterproof. For example, an inside layer 54 can be plastic film while the outer layer 56 is an opaque material to keep the contents hidden. The opaque layer can further comprise high-quality graphics such as those used on current onserts to carry a message to the consumer. An onsert 34 could further comprise a booklet on the outside surface 56. The onsert 34 can be fixed to the smokeless tobacco container 10 either permanently or temporarily using common adhesives. Exemplary materials that can be utilized to affix the onsert 34 to the smokeless tobacco container 10 may be low, moderate and high tack reclosable adhesives. These adhesives can be based on natural rubber, hot melt rubber (synthetic), acrylic or silicone.

Additionally, the flap 46 of the onsert 34 can be angled as shown in FIGS. 7 and 9 and one side 56 of the onsert 34 can have a corresponding slot 58 into which the flap 46 is inserted in order to hold the flap 46 in place and keep the onsert 34 closed. Alternatively, the flap 46 can include an adhesive on one side, such as low, moderate and high tack reclosable adhesives. These adhesives can be based on natural rubber, hot melt rubber (synthetic), acrylic or silicone. and can either permanently or temporarily hold the flap 46 in place.

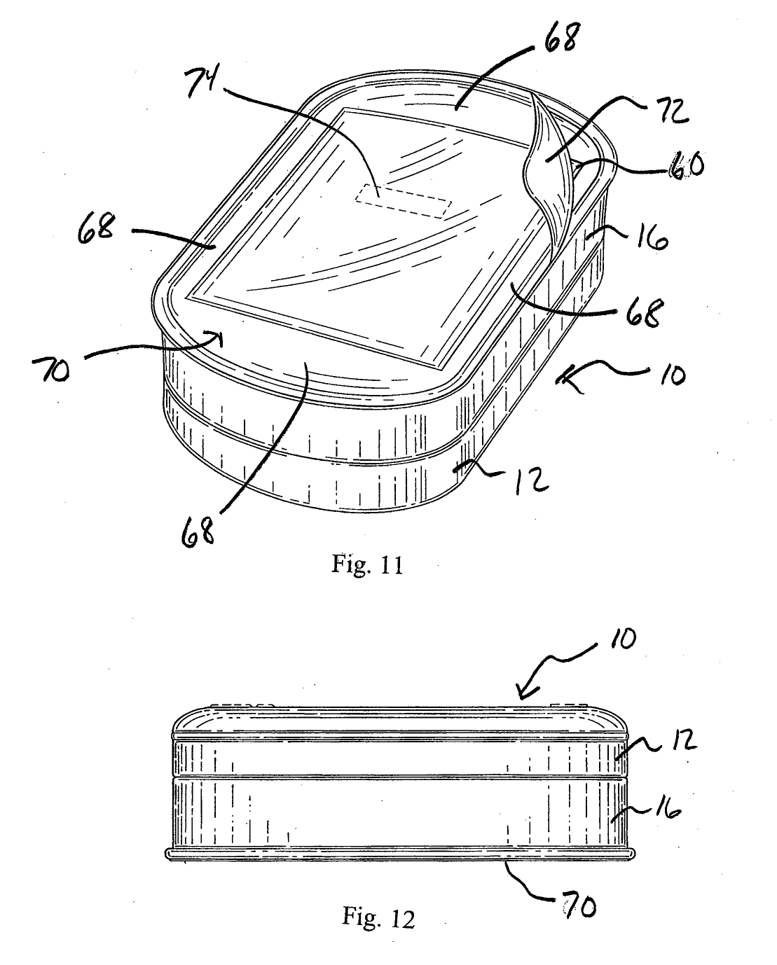

In an alternative embodiment shown in FIGS. 11-15, the onsert can be an appropriately sized plastic bag 60 with one open end 62. The bag 60 is sealed on three other sides 64. The bag 60 is attached to a substrate 70 coated with a reclosable adhesive. The substrate 70 is sized larger than the bag 60 to leave an adhesive layer 68 surrounding the bag 60. The substrate 70 can be paper, plastic or a laminate of paper/plastic, paper/foil, or plastic/foil, for example. Graphics can be applied to the substrate which would be visible from the side opposite of the adhesive. The adhesive side is applied to the container 10. If desired, a folded corner 72, or edge may be provided to allow for ease in opening. Alternatively, the corner or edge could be left free of adhesive. The bag 60 could have a small piece of pressure sensitive tape or adhesive 74 on one side of the bag 60 to attach bag 60 to the container 10. When the resealable substrate 70 is lifted, the substrate 70 pulls the bag 60 open and the adhesive 74 holds the opposite side of the bag 60 against the outside 56 of the tin 10. This allows the mouth 62 of the bag 60 to open while the bag 60 is still attached to the outside 56 of the tin 10. Other tapes could be used as the substrate or adhesives applied to the substrate as are known in the art.

In addition, the inside of the onsert 34 could contain a disinfectant or sanitizer to allow hygienic storage of the spent snus pouch 18. Examples of disinfectants include (but are not limited to) citric acid, thymol, and quarternary ammonium compounds such as alkyl dimethyl benzyl ammonium chlorides and alkyl dimethylethyl benzyl ammonium chlorides.

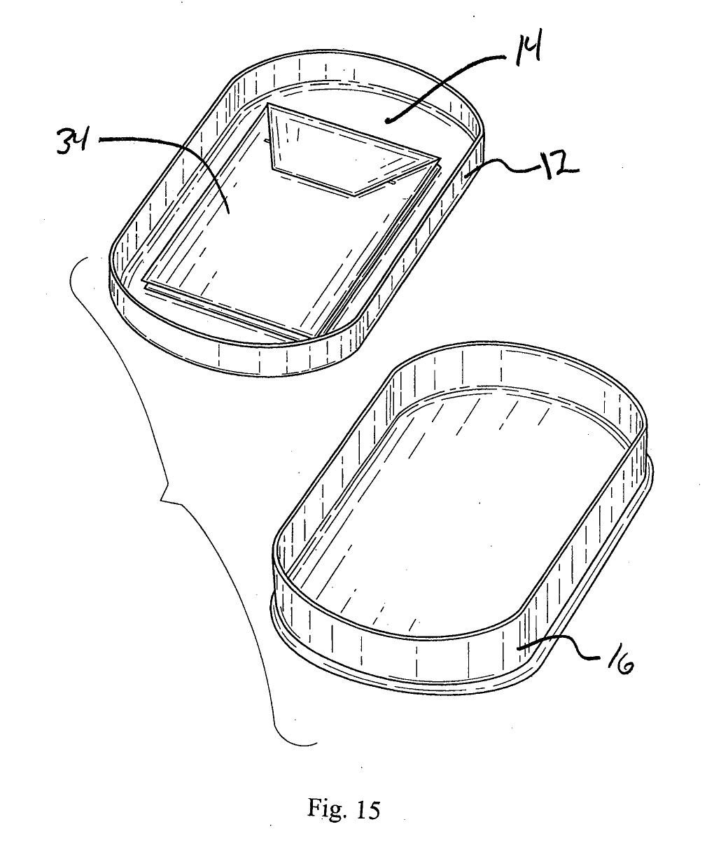

Onserts and methods of applying them to the outside of packages are disclosed in U.S. Pat. Pub. No. 2008/0128300 to Bahar et al., U.S. Pat. Nos. 7,228,961 to Koettner et al., 7,174,938 to Cadieux et al., 6,681,927 to Focke et al., 6,467,927 to Tallier et al., 5,250,134 to Thomas et al., and 2,011,399 to Driscoll, which are each hereby incorporated by reference in their entirety, and the present embodiments of the onsert 34 may be applied in the same fashion, or in any other fashion known to those skilled in the art. Alternatively, as shown in FIG. 15, the onsert 34 could be attached to the internal side 14 of the lid 12 of the smokeless tobacco container 10 to minimize the increase in size of the entire container 10.

In use, once a user is done with a pouch of a smokeless tobacco product, the user can place the used pouch in the onsert 34 and seal it closed, either permanently or temporarily. The material of the onsert 34 prevents the damp used pouch from staining a user's pocket, and eliminates the immediate need to find a disposal bin. Furthermore, the onsert 34 can be sized to accept the same number of pouches that are provided in the smokeless tobacco container 10.

Since many of the formats described are substantially flat until used, multiple layers of the described onserts 34 could also be applied such that when one layer is used, it could be removed for disposal when convenient, and another layer is exposed for subsequent use.

Moreover, the present onsert 34 could be utilized as a cigarette butt disposal unit as well if it were to be attached to a cigarette box. For example, the onserts 34 previously described could be lined with aluminum foil so as to better inhibit stale smoke smell from escaping the sealed onsert 34. Alternatively, the papers and plastics used could be laminated to aluminum foil. Alternatively, the plastic bag 60 previously described could be replaced with aluminum foil.

Finally, the onsert 34 could take any shape or size depending on the smokeless tobacco container 10 it is attached to, and how much material it needs to hold. The onsert 34 could also have printing or other designations on it to maximize its usefulness so that the manufacturer does not give up valuable advertising space on the outside of the smokeless tobacco container 10.

Referring to FIG. 1, there is shown an embodiment of a smokeless tobacco product 18 that can be placed in the containers described previously. The tobacco product 18 includes a moisture-permeable pouch 78. The illustrated pouch 78 is sealed closed along its length at an overlap region 82. The overlap region may be formed by sealing the bottom portion of one edge of the pouch 78 over the top portion of the opposite edge of the pouch (e.g., by heat sealing, suitable adhesive, or other suitable means). A solid tobacco material 80 is disposed within the pouch 82.

Suitable packets, pouches or containers of the type used for the manufacture of smokeless tobacco products are available under the trade names “taboka,” CatchDry, Ettan, General, Granit, Goteborgs Rape, GrovSnus White, Metropol Kaktus, Mocca Anis, Mocca Mint, Mocca Wintergreen, Kicks, Probe, Prince, Skruf, TreAnkrare, Camel Snus Original, Camel Snus Frost and Camel Snus Spice. The tobacco formulation may be contained in pouches and packaged, in a manner and using the types of components used for the manufacture of conventional snus products. The pouch or fleece provides a liquid-permeable container of a type that may be considered to be similar in character to the mesh-like type of material that is used for the construction of a tea bag. Components of the loosely arranged, granular tobacco formulation readily diffuse through the pouch 78 and into the mouth of the user.

In certain embodiments, an exemplary pouch 78 may be manufactured from materials, and in such a manner, such that during use by the user, the pouch 78 undergoes a controlled dispersion or dissolution. Such pouch materials may have the form of a mesh, screen, perforated paper, permeable fabric, or the like. For example, pouch material manufactured from a mesh-like form of rice paper, or perforated rice paper, may dissolve in the mouth of the user. As a result, the pouch 78 and tobacco formulation each may undergo complete dispersion within the mouth of the user during normal conditions of use, and hence the pouch 78 and tobacco formulation both may be ingested by the user. Other exemplary pouch materials may be manufactured using water dispersible film forming materials (e.g., binding agents such as alginates, carboxymethylcellulose, xanthan gum, pullulan, and the like), as well as those materials in combination with materials such as ground cellulosics (e.g., fine particle size wood pulp). Preferred pouch materials, though water dispersible or dissolvable, may be designed and manufactured such that under conditions of normal use, a significant amount of the tobacco formulation contents permeate through the pouch material prior to the time that the pouch undergoes loss of its physical integrity. If desired, flavoring ingredients, disintegration aids, and other desired components, may be incorporated within, or applied to, the pouch material.

Descriptions of various components of snus products and components thereof also are set forth in U.S. Pat. Pub. No. 2004/0118422 to Lundin et al., which is incorporated herein by reference. See, also, for example, U.S. Pat. Nos. 4,607,479 to Linden; 4,631,899 to Nielsen; 5,346,734 to Wydick et al.; and 6,162,516 to Derr, and U.S. Pat. Pub. No. 2005/0061339 to Hansson et al.; each of which is incorporated herein by reference. See, also, the representative types of pouches, and pouch material or fleece, set forth in U.S. Pat. No. 5,167,244 to Kjerstad, which is incorporated herein by reference. Snus products can be manufactured using equipment such as that available as SB 51-1/T, SBL 50 and SB 53-2/T from Merz Verpackungmaschinen GmBH. G.D SpA out of Italy also supplies tobacco pouching equipment. Snus pouches can be provided as individual pouches, or a plurality of pouches (e.g., 2, 4, 5, 10, 12, 15, 20, 25 or 30 pouches) and can be connected or linked together (e.g., in an end-to-end manner) such that a single pouch or individual portion can be readily removed for use from a one-piece strand or matrix of pouches.

The present invention also encompasses various additions and modifications to the fleece material of the pouches. The fleece materials used for the pouches are typically nonwoven materials. Materials such as liquids, encapsulated products, or powders can be incorporated into these nonwoven materials at various points during their manufacture to accomplish many different purposes such as: controlling the pH produced in the user's mouth upon insertion, flavoring, reducing the initial sting of the tobacco product in the mouth, coloring the fleece, or reducing discoloration of the nonwoven material. Exemplary fleece materials include BFF's SDH27 Natural Grade and BFF's SDH27 Brown.

Nonwovens such as those used in tobacco containing fleece pouches are textiles that are neither woven or knit. They are generally made by extruding a polymeric material into continuous filaments and then providing a type of bond such as meltblown, spunbond or spunlaid. Typical synthetic polymers used in manufacturing nonwovens are polypropylene and polyesters. Other types of nonwoven materials are typically manufactured by chopping the extruded filaments into small fibers to form a staple material, and then combining them together to form a net or web which is then bound in a various number of ways. For example, the fibers can be bound mechanically, with an adhesive, or utilizing a binder material. Two common nonwovens are staple nonwovens and spunlaid nonwovens.

Staple nonwovens are made in two steps. The extruded fibers are spun, cut to a few centimeters in length and baled. The bales are dispersed on a conveyor belt and the fibers are spread in a uniform web by a wetlaid, drylaid or airlaid process or by carding. Staple nonwovens are then bound, typically by using resin or thermal bonding.

Spunlaid nonwovens are made in one continuous process. Fibers are spun and then directly dispersed into a web by deflectors or can be directed with air streams. Spunlaid nonwovens are bonded either by resin or thermally.

There are also other methods of manufacturing nonwovens such as starting with films and fibrillate and serrating or vacuum-forming them with patterned holes. These methods are commonly known in the art.

Several bonding methods can also be used depending on the type of nonwoven that is being manufactured. Thermal bonding comprises applying heat to the nonwoven, and hydroentaglement comprises mechanical intertwining of fibers by water jets. Ultrasonic pattern bonding can also be utilized, and needlefelt comprises mechanical intertwining of fibers by needles. Chemical bonding is also possible using binders such as latex emulsion or solution polymers to chemically join the fibers. Chemical bonding can also be used with binder fibers or powders that soften and melt to hold other non-melting fibers together. One type of cotton staple nonwoven is treated with sodium hydroxide to shrink bond the mat by causing the cellulose-based fibers to curl up and shrink around each other. Finally, meltblown means that the nonwovens are weakly bonded from the air attenuated fibers intertangling with themselves during web formation as well as the temporary tackiness when they are forming.

It is known that nonwoven substrate material can be produced that can give off an aroma and/or a flavor, particularly when moistened. Such a nonwoven substrate and a method for forming it is set forth in U.S. patent application Ser. No. 10/219,111 to Tharreau which is herein incorporated by reference in its entirety. The nonwoven substrate of Tharreau is formed through a process comprising a stage of thermal attachment of cyclodextrin particles to the nonwoven substrate. The resulting product is able to give off an aroma and/or a flavor when it is subsequently moistened with water, or when placed in a user's mouth.

Many different additives, as described above, could be added to the nonwoven during manufacture. For example, as set forth in U.S. patent application Ser. No. 12/014,525, to Robinson et al., buffers are commonly used in snus formulations to maintain the pH levels during shipping and storage without the need for refrigeration. These buffers are typically added to the snus tobacco formulation themselves, but in the present embodiment of the invention, the buffer solution is also added directly to the nonwoven pouch material during manufacture. In one embodiment of the present method, the buffer solution is added to the polymer material before extrusion of the fiber into filaments. In an alternative embodiment, the extruded fibers are soaked in the buffer solution after extrusion. It is typically added to the snus formulation in an amount that is about 3-12% of the dry weight of the snus formulation. As disclosed in U.S. patent application Ser. No. 12/014,525, to Robinson et al., improved buffering characteristics over time can be obtained by using sodium carbonate and sodium bicarbonate at a ratio of between about 1:75 and about 1:80, although ratios from 1:20 up to 1:99 are also effective.

This method can also be used to incorporate an analgesic into the fleece material, such as oil of cloves, eugenol, or other chemical compounds capable of providing analgesic effects. The compounds can vary depending on whether the product was designed for over the counter or prescription use. The use of such analgesics in the pouch can reduce the initial sting that is sometimes felt by a user upon insertion of the snus pouch into the mouth.

Analgesics can include opioids and other medicaments such as morphine, mepidine, dentanyl, sufentranil, alfentanil, aspirin, acetaminophen, ibuprofen, indomethacine, naproxen, atrin, isocome, midrin, axotal, firinal, phrenilin, ergot, and ergot derivatives (wigraine, cafergot, ergostat, ergomar, dihydroergotamine), imitrex, and ketoprofen. Such medicaments have been used in the past in over-coated chewing gum formulations, as disclosed in U.S. Pat. No. 6,773,716 to Ream et al., which is herein incorporated by reference in its entirety. When an analgesic is incorporated into the fleece, the analgesic loading levels are such that during use, the analgesic is released into the saliva and absorbed through the oral mucosa.

Effervescent substances can also be added to the snus tobacco or directly to the fleece pouch to aid in absorption of medicaments into the buccal cavity. See U.S. Pat. No. 6,974,590 to Panther et al. Effervescent compositions have also been employed for use as taste masking agents in dosage forms which are not dissolved in water prior to administration. For example, U.S. Pat. No. 4,639,368 to Niazi et al. describes a chewing gum containing a medicament capable of absorption through the buccal cavity and containing a taste masking amount of an effervescent.

More recently effervescents have been employed to obtain rapid dissolution and/or dispersion of the medicament in the oral cavity. See U.S. Pat. Nos. 5,178,878 and 5,223,264 to Wehling et al. The effervescent tends to stimulate saliva production thereby providing additional water to aid in further effervescent action. These dosage forms give an agreeable presentation of the drug, particularly for patients who have difficulty in swallowing tablets or capsules. PCT Pub. No. WO 97/06786 to Johnson et al. describes pre-gastric absorption of certain drugs using rapidly-disbursing dosage forms. An example of adding an effervescent material to a hydroentangled textile is disclosed in U.S. Pat. No. 7,381,667 to Bergquist et al.

Another method to reduce bitterness in the products that is encompassed by the present invention is to add citric acid to the pouch. Citric acid can enhance the flavor notes of the product and can reduce bitterness as well. Other methods of reducing bitterness include the addition of propolis or eucalyptus to the pouch. Furthermore, these materials can be added to the tobacco directly, as disclosed in U.S. Pat. No. 6,668,839 to Williams. Alternatively, the tobacco itself can be aged or ground in a specific manner to remove bitterness. Fillers, sweeteners, and casing agents, as well as other materials, can be used alone or in combination to obtain the desired flavor and mouth feel for the user.

Another method for controlling the mouth feel and taste of a snus or other smokeless tobacco product is to utilize so called “miracle fruit” berries. These red berries form the tropical plant called miracle fruit, Richadella dulcifica or Synsepalum dulcificum, reduce the sour and bitter taste of acids and add sweet and palatable taste. The miracle fruit berries contain a taste-modifying glycoprotein, miraculin, which is comprised of 191 amino acids, includes carbohydrate residues and has a molecular mass of 24,600 (Jrnl. of Bio. Chem. 1989, 264, 6655-6659). The native miraculin protein is a tetramer held together by several disulfide bridges. The taste modification is well established and described in U.S. Pat. No. 3,849,555 to Harvey. Sources of the fruit are found in Western Africa, as well as in Florida, USA. The fruit and fruit extract are available commercially through various suppliers. The isolated miraculin protein is also commercially available, most likely purified via methodology described in U.S. Pat. No. 5,886,155 to Armah et al.

Incorporation of miracle fruit, extract, or isolated miraculin into “smokeless” tobacco articles such as snus is accomplished by crushing and dehydrating the fruit to obtain an extract, or using commercially available extract or isolated protein (extracts). The extracts may be added directly to the tobacco before processing, during processing, or cased onto a finished “smokeless” tobacco product by embedding or coating the snus fleece with the extracts. Miracle fruit may also be added to other smokeless tobacco products such as rods, sticks, tubes and other types as disclosed in U.S. Pat. Pub. No. 2008/0029110 to Dube et al., which is herein incorporated by reference in its entirety.

According to U.S. Pat. No. 3,681,087 to Johnson, the unit dosage of miracle fruit extract is between 0.1 and 50 mg, with an optimum inclusion for taste modification between 20 and 30 mg. In regards to purified protein, it is currently unknown what inclusion level would be required for the desired effect. Since the taste-modification of miraculin is dependent upon an acidic environment, the processing of tobacco would need to result in a tobacco saliva solution possessing an acidic pH. Current applications for snus processing require the addition of sodium bicarbonate, which moves this pH towards basicity. This step would be removed, though a bitter taste would be expected, however, subsequently modified by miraculin inclusion. Fewer sweeteners would need to be added to the smokeless product, as the bitter acid taste of the tobacco constituents in the smokeless product would be modified into a sweet taste in the presence of miraculin.

Mouth feel can also be controlled by controlling the way the pouch allows elements to leech out of the pouch into a user's mouth. The pouch can be constructed such that only certain areas of the pouch are permeable, thus controlling the rate of absorption through the buccal cavity.

Another method of controlling mouth feel in a snus tobacco product is to incorporate a form of effervescence into either the tobacco itself, or into the snus fleece pouch as previously described.

Finally, a drawback to fleece snus pouches is that they tend to stain and discolor over time. Another embodiment of the present invention solves this problem by incorporating an additive, such as ethylcellulose or nitrocellulose, to the nonwoven material. Alternatively, the method can encompass rotogravure printing the side of the pouch that comes into contact with the tobacco in this fashion. The pouch could also be coated with alkyl ketene dimer (CAS #144245-85-2). Another method to retard discoloration is to use two separate layers of fleece. The inside layer would retard the transfer of colorants from the tobacco to the outside layer. The inside layer could be made of lighter weight material since the purpose is to act as a spacer to prevent contact of tobacco with the outer layer, not add to the structural strength of the pouch. The inside layer could also be made of different materials such as lightweight, porous paper or a fine mesh.

A snus pouch could also be used to create a tea-type drink. For example, a snus pouch such as those described above could be soaked in an 8 ounce glass of hot or cold water. The pouch would be allowed to soak or steep in the water for an amount of time so that the tobacco flavor could leach into the water. The tobacco-flavored beverage could than be enjoyed.

Another embodiment of the present invention encompasses adding colorants such as dyes and inks to the nonwoven pouch material to add luster or shine as well as to identify flavors. For example, cinnamon flavored snus could have a red tinted pouch, and mint flavored snus could be provided in a green tinted pouch. Other flavors and corresponding colors are contemplated. The fleece could also be printed with dissolvable materials to identify the type of snus, such as “Camel” or the flavor, such as “mint.” Additionally, the inks and dyes could carry additional flavors or other substances. Furthermore, polymers can be engineered to provide certain characteristics such as solubility and degradability.

Tobaccos used for the manufacture of tobacco products pursuant to the embodiments herein may vary. The tobaccos may include types of tobaccos such as flue-cured tobacco, burley tobacco, Oriental tobacco, Maryland tobacco, dark tobacco, dark-fired tobacco and Rustica tobaccos, as well as other rare or specialty tobaccos. Descriptions of various types of tobaccos, growing practices, harvesting practices and curing practices are set forth in Tobacco Production, Chemistry and Technology, Davis et al. (Eds.) (1999), which is incorporated herein by reference. See, also, the types of tobaccos that are set forth in U.S. Pat. Nos. 4,660,577 to Sensabaugh, Jr. et al.; 5,387,416 to White et al.; 6,730,832 to Dominguez et al.; and 7,025,066 to Lawson et al.; U.S. Pat. Pub. Nos. 2007/0062549 to Holton, Jr. et al. and 2007/0186941 to Holton, Jr. et al.; and U.S. patent application Ser. No. 11/781,666 to Humphrey, each of which is incorporated herein by reference. Most preferably, the tobacco materials are those that have been appropriately cured and aged. Especially preferred techniques and conditions for curing flue-cured tobacco are set forth in Nestor et al., Beitrage Tabakforsch. Int., 20 (2003) 467-475 and U.S. Pat. No. 6,895,974 to Peele, which are incorporated herein by reference. Representative techniques and conditions for air curing tobacco are set forth in Roton et al., Beitrage Tabakforsch. Int., 21 (2005) 305-320 and Staaf et al., Beitrage Tabakforsch. Int., 21 (2005) 321-330, which are incorporated herein by reference. See, also U.S. Pat. No. 6,834,654 to Williams.

Tobacco such as that used in snus marketed under the trade names Camel Snus Frost, Camel Snus Original and Camel Snus Spice by R. J. Reynolds Tobacco Company can also be used. Typically, types of tobacco having 1% or less than 1% nicotine content are used in these formulations and the collective nicotine content of the tobacco blend is near about 2% the dry weight of the tobacco, often less than 1.5% of the dry weight of the tobacco, frequently 0.5%-1.25% the dry weight of tobacco and often 1% or less of the dry weight of the tobacco.

The tobacco used for the manufacture of the tobacco product preferably is provided in a shredded, ground, granulated, fine particulate or powder form. The tobacco used for the manufacture of the tobacco product also can be processed, blended, formulated, combined and mixed with other materials or ingredients. For example, the tobacco composition can incorporate salts, sweeteners, binders, colorants, pH adjusters or buffers, fillers, flavoring agents, disintegration aids, antioxidants, humectants, and preservatives. See, for example, those representative components, combination of components, relative amounts of those components and ingredients relative to tobacco, and manners and methods for employing those components, set forth in U.S. Pat. Pub. Nos. 2007/0062549 to Holton, Jr. et al., 2007/0186941 to Holton, Jr. et al., and 2008/0029110 to Dube et al., each of which is incorporated herein by reference. For example, the tobacco product can have the form of a pouch containing a tobacco composition, and a flavored strip or film; the form of a pouch containing a tobacco composition, and a flavored strip or film incorporating finely divided granules of tobacco and/or tobacco extract (e.g., components of a spray dried aqueous extract of tobacco); or the form of a highly processed dissolvable film incorporating finely divided granules of tobacco and/or tobacco extract. Typically, for certain embodiments, the amount of tobacco material within a portion of an individual portion of a smokeless tobacco can be, on a dry weight basis, at least about 30 mg, often at least about 40 mg, and frequently at least about 45 mg; while that amount typically is less than about 200 mg, often less than about 150 mg, and frequently less than about 100 mg. The tobacco material can have the form of processed tobacco parts or pieces, cured and aged tobacco in essentially natural lamina or stem form, a tobacco extract, extracted tobacco pulp (e.g., using water as a solvent), or a mixture of the foregoing (e.g., a mixture that combines extracted tobacco pulp with granulated cured and aged natural tobacco lamina).

A blend of different types of tobacco can also be used. For example, a mixture can contain a blend of 75% flue cured tobacco and 25% other types of tobacco such as burley, Turkish, dark air cured or rare specialty tobaccos. Or, the blend could be 100% of one type of tobacco, such as flue cured.

The moisture content of the tobacco formulation prior to use by a consumer of the formulation may vary. Typically, the moisture content of the tobacco formulation, as present within the pouch prior to insertion into the mouth of the user, is less than about 55 weight %, generally is less than about 50 weight %, and often is less than about 45 weight %. Certain types of tobacco formulations have moisture contents, prior to use, of less than about 15 weight %, frequently less than about 10 weight %, and often less than about 5 weight %. For certain tobacco products, such as those incorporating snus-type tobacco compositions, the moisture content may exceed 20 weight %, and often may exceed 30 weight %. For example, a representative snus-type product may possess a tobacco composition exhibiting a moisture content of about 25 weight % to about 50 weight %, preferably about 30 weight % to about 40 weight %.

The manner by which the moisture content of the formulation is controlled may vary. For example the formulation may be subjected to thermal or convection heating. As a specific example, the formulation may be oven-dried, in warmed air at temperatures of about 40° C. to about 95° C., with a preferred temperature range of about 60° C. to about 80° C. for a length of time appropriate to attain the desired moisture content. Alternatively, tobacco formulations may be moistened using casing drums, conditioning cylinders or drums, liquid spray apparatus, ribbon blenders, mixers available as FKM130, FKM600, FKM1200, FKM2000 and FKM3000 from Littleford Day, Inc., Plough Share types of mixer cylinders, and the like. Most preferably, moist tobacco formulations, such as the types of tobacco formulations employed within snus products, are subjected to pasteurization or fermentation. Techniques for pasteurizing or fermenting snus types of tobacco products will be apparent to those skilled in the art of snus product design and manufacture.

The acid or base content of a tobacco formulation gives it the ability to produce a pH. In the present application, “the pH of the tobacco” refers to the ability of the tobacco to produce a certain pH level. The pH of the tobacco formulation can vary. Typically, the pH of that formulation is at least about 6.5, and preferably at least about 7.5. Typically, the pH of that formulation will not exceed about 9, and often will not exceed about 8.5. A representative tobacco formulation exhibits a pH of about 6.8 to about 8.2. A representative technique for determining the pH of a tobacco formulation involves dispersing 2 g of that formulation in 10 ml of high performance liquid chromatography water, and measuring the pH of the resulting suspension/solution (e.g., with a pH meter).

If desired, a buffer can be added to the snus formulation to help maintain the pH levels during shipping and storage without the need for refrigeration. Sodium carbonate alone has been used as a buffer in the past. It is typically added to the snus formulation in an amount that is about 3-12% of the dry weight of the snus formulation. It has been discovered that a new combination of elements provides improved buffering characteristics over time, and when combined with the modified atmosphere packaging described later, the combination nearly eliminates any significant change in pH in snus formulations over time without the need for traditional refrigeration. The preferred buffer formulation is sodium carbonate and sodium bicarbonate at a ratio of between about 1:75 and about 1:80, although ratios from 1:20 up to 1:99 are also effective.

If such a buffer is desired, water is added to a snus tobacco blend to bring the formulation to about 35-36% moisture content. Salt can be added at the level desired, for example at 1.5% of the dry weight of the snus formulation. The mixture is pasteurized at about 212° F. (100° C.) for one hour. The mixture is then brought up to between 50% and 55% moisture content in a solution of the buffer made up of sodium carbonate and sodium bicarbonate in the ratios detailed above. The buffer is added to the snus formulation in an amount that is about 7-15% of the dry weight of the snus formulation bringing the pH from about 9-9.5. The snus is then heated at about 175-185° F. until the pH drops to about 8.0 to 8.3.

Other buffer recipes are also contemplated, although they may not exhibit the same synergy that the sodium carbonate/sodium bicarbonate buffer does in conjunction with carbon dioxide modified atmosphere packaging. Other buffer recipes include sodium carbonate and ammonium bicarbonate at a ratio of 2:3, potassium hydroxide and sodium bicarbonate at a ratio of 1:75, sodium hydroxide and potassium bicarbonate at a ratio of 1:75, and potassium hydroxide, sodium carbonate and sodium bicarbonate at a ratio of 2:5:3. These buffer recipes can be added to the snus formulation as described above, in an amount that is about 7-15% of the dry weight of the snus formulation.

If desired, prior to preparation of the tobacco formulation, the tobacco parts or pieces may be irradiated, or those parts and pieces may be pasteurized, or otherwise subjected to controlled heat treatment. Additionally, if desired, after preparation of all or a portion of the formulation, the component materials may be irradiated, or those component materials may be pasteurized, or otherwise subjected to controlled heat treatment. For example, a formulation may be prepared, followed by irradiation or pasteurization, and then flavoring ingredient(s) may be applied to the formulation. Alternatively, the tobacco formulation can be irradiated or pasteurized after the tobacco formulation has been incorporated within a moisture-permeable packet or pouch (e.g., so as to provide individual containers of snus-type smokeless tobacco product.

Typically, the amount of tobacco formulation within each individual portion (e.g., within each snus-type pouch) is such that there is at least about 50 mg, often at least about 150 mg, and frequently at least about 250 mg, of dry weigh tobacco; and less than about 700 mg, often less than about 500 mg, and frequently less than about 300 mg, of dry weight tobacco. For example, snus-type smokeless tobacco products can have the form of so-called “portion snus.”

One exemplary snus-type product possesses about 1 g of a tobacco formulation having a moisture content of about 35 weight %; which tobacco formulation is contained in a sealed fleece pouch having an overall length of about 30 mm, a width of about 16 mm, and a height of about 5 mm, wherein the length of the compartment area of that pouch is about 26 mm due to a seal of about 2 mm width at each end of that pouch. Another exemplary snus-type product possesses about 0.5 g of a tobacco formulation having a moisture content of about 35 weight %; which tobacco formulation is contained in a sealed fleece pouch having an overall length of about 26 mm, a width of about 12 mm, and a height of about 5 mm, wherein the length of the compartment area of that pouch is about 22 mm due to a seal of about 2 mm width at each end of that pouch.

Snus pouching is typically performed as an automated, fast-moving process utilizing machines that have been developed to portion the tobacco without clumping or excessive drying. However, clumping still commonly occurs in machines that utilize a single feed screw in the tobacco feed hopper to move the tobacco into the pouching machine. Examples of tobacco pouching machines are disclosed in PCT Pub. No. WO 08/062,302 to Boldrini and PCT Pub. No. WO 08/56135 to Onno.

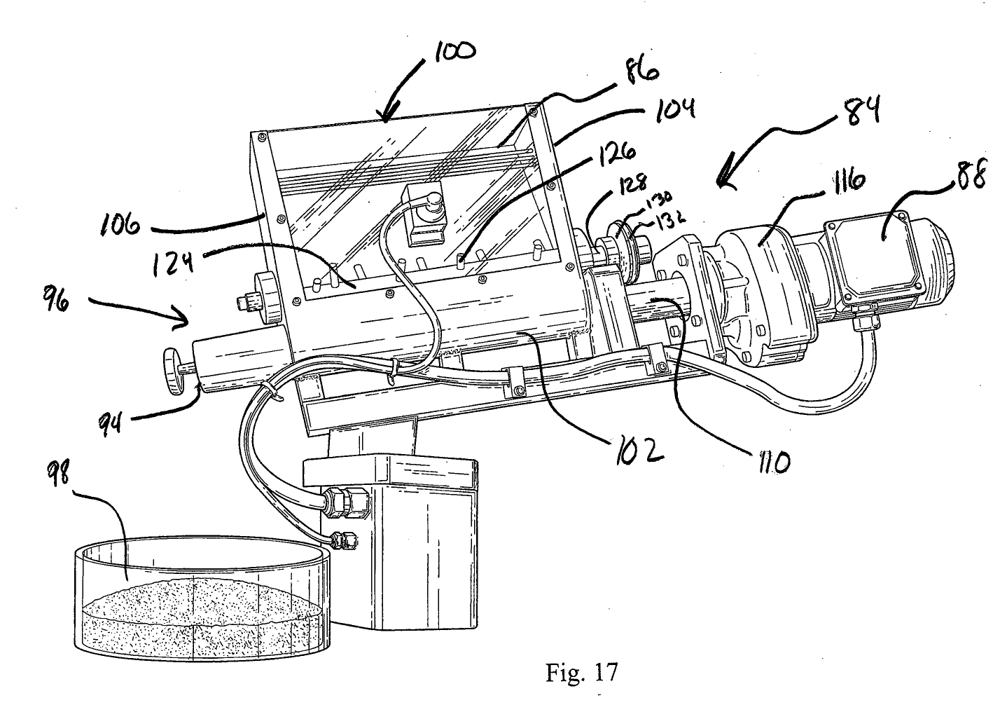

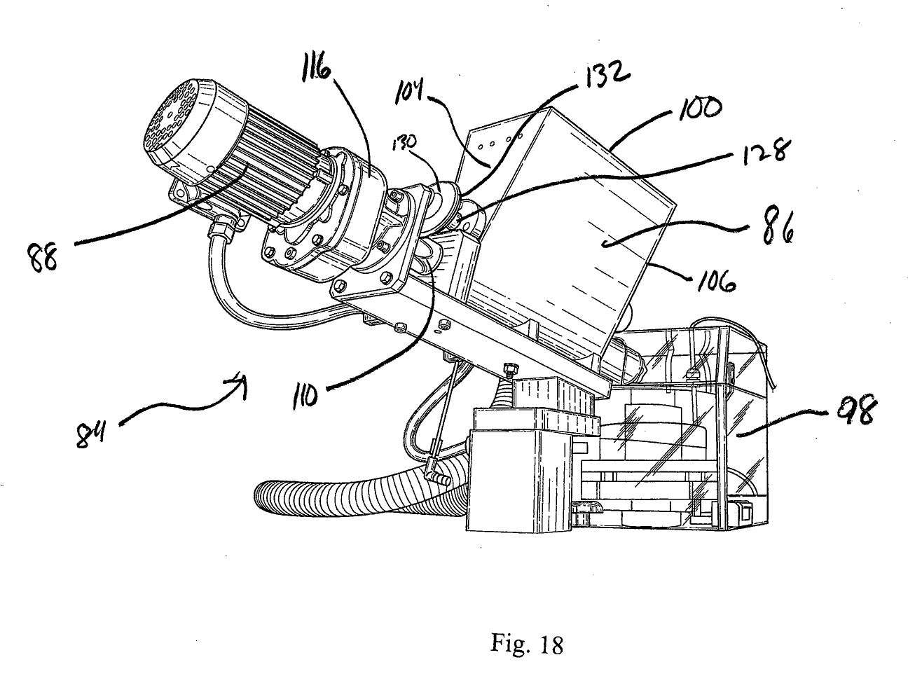

Equipment for packaging the snus formulations into the pouches referenced above will be herein described with reference to FIGS. 17-21. The figures illustrate the infeed and metering system 84 of a typical tobacco pouching machine manufactured by Merz Verpackungsmaschinen GmbH with an inventive modification to improve the tobacco flow through the feed hopper 86. The infeed and metering system 84 typically comprises a feed hopper 86, a motor 88, a feed or “metering” screw 90 with corresponding pins 92, a discharge hole 94 on a discharge side 96 of the feed hopper 86, and a corresponding dosing bowl 98.

The feed hopper 86 includes first 104 and second 106 ends with the discharge hole positioned on the side wall 108 of the second end 104. The hopper 86 is typically about 5.5 inches wide at the top 100 and about 2.25 inches wide at the bottom 102. The overall height of the hopper 86 is about 11.75 inches and the overall length of the hopper 86 is about 11.5 inches. These dimensions are exemplary only, and other hopper sizes can be used as known in the art. The hopper 86 is positioned so that it slopes down from the first end 104 to the second end 106 to ensure that tobacco 120 in the feed hopper 86 flows from the first end 104 to the second end 106, or discharge side, of the feed hopper 86.

A feed screw 90 is positioned near the bottom 102 of the feed hopper 86 such that it can freely rotate without the pins 92 coming into contact with the sides 108 or bottom 102 of the feed hopper 86. The feed screw 90 extends laterally across the entire bottom of the feed hopper 86, and has a shaft 110 extends out of both the first end 104 of the feed hopper 86 and the discharge hole 94 of the feed hopper 86. A plurality of pins 92 extend from the perimeter of the feed screw 90. On the end of the feed screw 90 opposite the end positioned at the discharge hole 94, the feed screw 90 extends through an opening in the hopper 86 and interfaces with a motor 114 through a gearbox 116. The motor 88 that powers the feed screw 90 is typically a 0.18 kw motor and powers a gearbox 116 which provides a fixed rotational speed of about 120 RPM. Other motors and gearboxes known in the art may also be used.

The feed screw 90 is typically about 2 inches in diameter, and the pitch of the pins 92 extending from the feed screw 90 is about 1 turn in 2 inches. The diameter of the feed screw 90 and the pitch of the pins 92 can be adjusted accordingly as known in the art. In operation, tobacco enters the feed hopper 86 at the top 100 and the rotation of the feed screw 90 along with the pitch of the pins 92 moves the tobacco toward the discharge hole 94 into the dosing bowl 98.

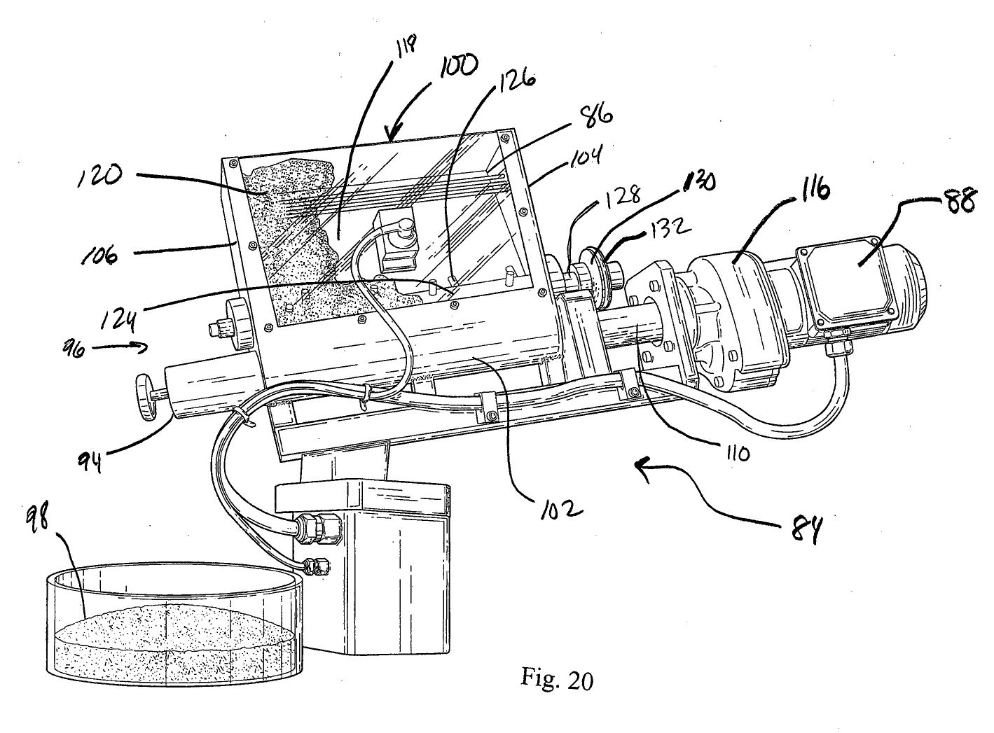

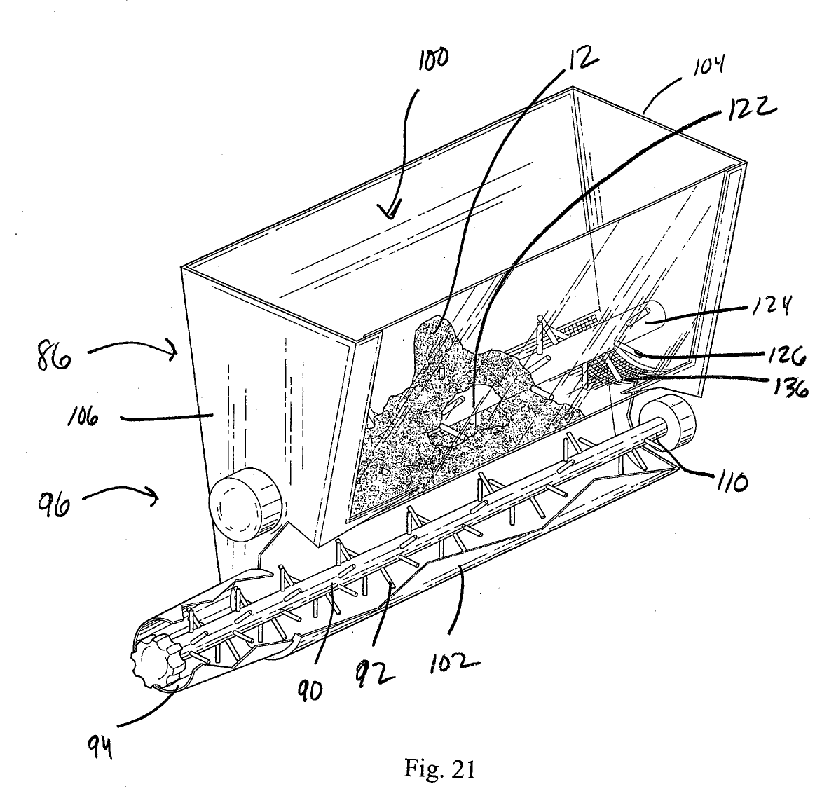

However, typical infeed and metering systems have inherent problems that cause down time and reduce efficiency. Referring to FIG. 20, a dead zone 118 typically occurs near the second end 106 of the feed hopper 86 as the tobacco 120 feeds through the feed hopper 86 with the assistance of the feed screw 90. An operator has to regularly stop the machine to unpack this dead zone 118 and push the tobacco 120 back into the feed screw 90 in order to keep the tobacco flow consistent. Furthermore, the tobacco 120 supplied to the feed hopper 86 in traditional machines tends to build up and cling to the side walls 108 of the feed hopper 86 because of its high moisture content. This results in a “rat hole” 122 in an area of the feed hopper 86 which starves the feed screw 90 and the dosing bowl 98 downstream from the feed screw 90 as shown in FIG. 21. This also causes equipment down time.

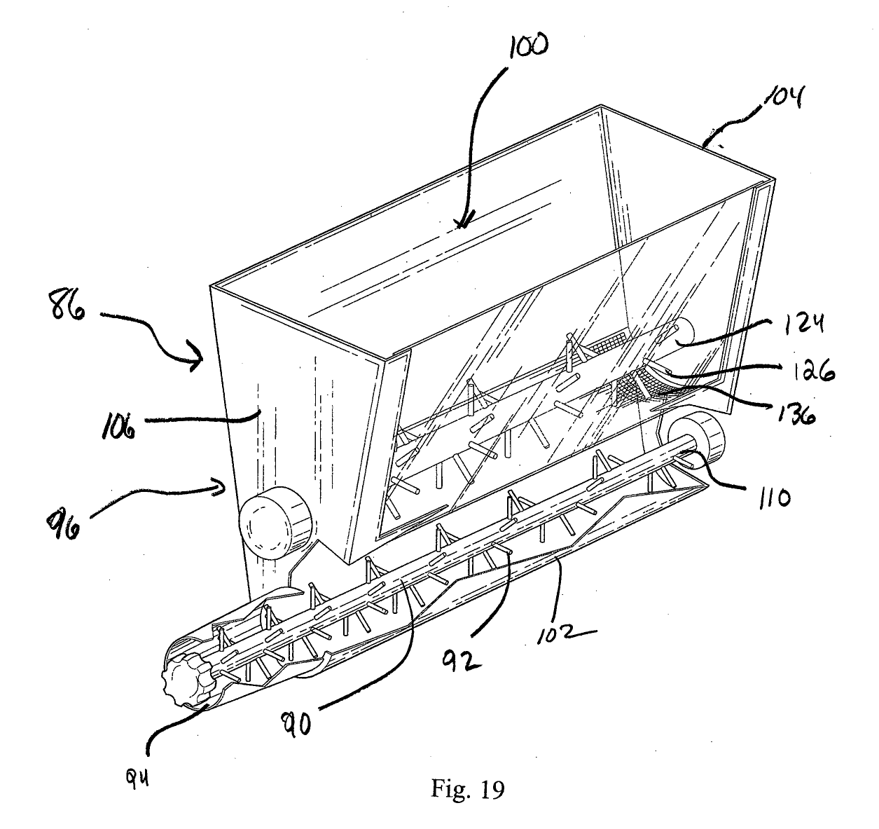

The present invention comprises a modified infeed and metering system 84 of a pouching machine such as illustrated in FIGS. 17-21. The modified pouching machine of the present invention includes an additional agitator screw 124 positioned above the feed screw 90. The agitator screw 124 includes a plurality of pins 126 extending from its perimeter, and it conveys tobacco 120 in an opposite or neutral direction from the feed screw 90 in order to move the tobacco 120 away from the dead zone 118 and eliminate the rat holes 122. The direction of the tobacco 120 as a result of the feed screw 90 and the agitator screw 124 are shown by arrows A and B respectively in FIG. 19.

The agitator screw 124 in preferably configured with as large a diameter as possible, and is spaced so as not to interfere with the feed screw 90. A preferred diameter for the agitator screw 124 is about three inches. Furthermore, the pitch of the agitator screw pins 126 is neutral or opposite the pitch of the feed screw pins 92. The agitator screw 124 includes a pulley system defined on the shaft 128 nearest the motor 88 and gearbox 116. The wheel 130 of the pulley system has a band 132 extending around its circumference. The agitator screw 124 is positioned through an opening in the first end 104 of the feed hopper 86 such that the band 132 is in contact with the outer diameter of the shaft 110 of the feed screw 90. The band 132 is preferably made from a material which provides enough friction so that when the feed screw 90 rotates, the wheel 130 rotates in the opposite direction of the feed screw 90 and in turn rotates the agitator screw 124. The ratios between the wheel 130 and the feed screw 90 diameter are such that the agitator screw 124 rotates at around 192 RPM.

In operation, the agitator screw 124 preferably turns at a faster rate than the feed screw 90. A preferred configuration is to mechanically drive the agitator screw 124 at a 1:6 to 1 ratio. The speed, direction of rotation and positioning of the agitator screw 124 versus the feed screw 90 breaks up the agglomerated tobacco particles and prevents the formation of dead zones 118 and rat holes 122. This results in a more efficient pouching process, as the machinery does not have to be stopped regularly to be cleaned out.

Optionally, a screen 136 can be positioned between the agitator screw 124 and the feed screw 90 in order to further reduce agglomerated particles and improve processing of the tobacco. A preferred mesh size for such a screen is a #6 Tyler screen, but other screens could be utilized as known in the art.

It should be noted that there could be a wide range of changes made to the present embodiments without departing from the scope of the claimed invention. It is therefore intended that the foregoing detailed description be regarded as illustrative rather than limiting, and that it be understood that it is the following claims, including all equivalents, that are intended to define the spirit and scope of this invention.

What is claimed is:

1. A method for preventing packing of tobacco in a tobacco hopper, said method comprising the steps of:
providing a feed screw with a plurality of pins extending from an outer diameter of said feed screw;
providing an agitator with a plurality of pins extending from an outer diameter of said outer diameter; and
rotating said feed screw and said agitator screw in opposite directions to move tobacco through said hopper, wherein said agitator screw rotates at a ratio of about 1:6 to 1 as compared to the feed screw.

2. The method of claim 1, further comprising the step of providing a screen between said feed screw and said agitator screw.

3. The method of claim 1, wherein the angle between the pins on the feed screw and the feed screw is equal to the angle between the pins on the agitator screw and the agitator screw.

4. The method of claim 1, wherein the angle between the pins on the feed screw and the feed screw is the opposite of the angle between the pins on the agitator screw and the agitator screw.

5. The method of claim 4, wherein the diameter of said agitator screw is about three inches.

6. The method of claim 1, wherein said feed screw further comprises a first shaft extending outside of said tobacco hopper, and said agitator screw further comprises a second shaft extending outside of said tobacco hopper.

7. The method of claim 6, wherein said second shaft has a wheel defined on said second shaft.

8. The method of claim 6, wherein at least a portion of the outer circumference of said wheel is in contact with at least a portion of an outer circumference of said first shaft.

9. The method of claim 8, wherein the step of rotating said feed screw and said agitator screw in opposite directions to move tobacco through said hopper is accomplished by the interaction of said wheel with said first shaft.

10. The method of claim 9, further comprising a band positioned on the circumference of said wheel, said band providing a frictional interaction with said first shaft.

11. The method of claim 1, wherein the pitch of the pins extending from the feed screw is about 1 turn in 2 inches.

12. The method of claim 7, wherein the ratio between said wheel and said agitator screw is such that the agitator screw rotates at around 192 RPM.
